(19) United States
(12) Patent Application Publication
(10) Pub. No.: US 2025/0116854 A1
(43) Pub. Date: Apr. 10, 2025

(54) OPTICAL UNIT AND ENDOSCOPE

(71) Applicant: OLYMPUS MEDICAL SYSTEMS CORP., Tokyo (JP)

(72) Inventors: Junya HARADA, Tachikawa-shi (JP); Kazuki AKIYAMA, Hachioji-shi (JP); Tatsuhiko OKITA, Akishima-shi (JP)

(73) Assignee: OLYMPUS MEDICAL SYSTEMS CORP., Tokyo (JP)

(21) Appl. No.: 18/904,226

(22) Filed: Oct. 2, 2024

Related U.S. Application Data
(60) Provisional application No. 63/542,566, filed on Oct. 5, 2023.

(51) Int. Cl. G02B 23/24; G02B 23/26

(52) U.S. Cl. CPC G02B 23/2438; G02B 23/2484; G02B 23/26

(57) ABSTRACT

An optical unit includes: a lens unit including a fixed lens and a movable lens; a frame; a movable portion located inside the frame; a first slider slidably arranged in a space between the frame and the movable portion; and a stopper arranged in the space, the stopper made of a non-metal material. The fixed lens is located in a distal section of the frame. The movable lens is located in the movable portion and the movable portion is movable relative to the frame along an optical axis of the optical unit between a biased state and an unbiased state. In the biased state: the stopper is spaced apart from the frame. In the unbiased state: the stopper contacts the frame.

### CROSS-REFERENCE TO RELATED APPLICATION

This application is based on and claims priority under 35 U.S.C. § 119 to U.S. Provisional Application No. 63/542, 566, filed Oct. 5, 2023, the entire contents of which are incorporated herein by reference.

### BACKGROUND

### 1. Technical Field

The present disclosure relates to an optical unit and an endoscope.

### 2. Related Art

In the related art, a technique has been disclosed in which an electromagnetic drive actuator that includes a movable portion having a movable lens provided therein, and that uses a coil and a magnet as a zoom function for changing an imaging magnification and as a focusing function for adjusting a focus by moving the movable lens portion back and forth relative to a fixed portion, that is, a voice coil motor, is applied to an endoscope (for example, refer to International Publication Pamphlet No. WO2023/084656).

### SUMMARY

In some embodiments, an optical unit includes: a lens unit including a fixed lens and a movable lens; a frame; a movable portion located inside the frame; a first slider slidably arranged in a space between the frame and the movable portion; and a stopper arranged in the space, the stopper made of a non-metal material. The fixed lens is located in a distal section of the frame. The movable lens is located in the movable portion and the movable portion is movable relative to the frame along an optical axis of the optical unit between a biased state and an unbiased state. In the biased state: the stopper is spaced apart from the frame. In the unbiased state: the stopper contacts the frame.

### BRIEF DESCRIPTION OF THE DRAWINGS

FIG. 1 is a perspective view illustrating a configuration of an optical unit according to a first embodiment of the disclosure.

FIG. 2 is an exploded perspective view (Part 1) illustrating the configuration of the optical unit according to the first embodiment of the disclosure.

FIG. 3 is an exploded perspective view (Part 2) illustrating the configuration of the optical unit according to the first embodiment of the disclosure.

FIG. 4 is a plan view illustrating the configuration of the optical unit according to the first embodiment of the disclosure.

FIG. 5 is an A-A cross-section (Part 1) of the optical unit illustrated in FIG. 4.

FIG. 6 is an A-A cross-section (Part 2) of the optical unit illustrated in FIG. 4.

FIG. 7 is a perspective view (Part 1) illustrating a configuration of a fixing-portion main body of the optical unit according to the first embodiment of the disclosure.

FIG. 8 is an enlarged view of a part of the fixing portion of the optical unit according to the first embodiment of the disclosure.

FIG. 9 is a perspective view (Part 2) illustrating a configuration of the fixing-portion main body of the optical unit according to the first embodiment of the disclosure.

FIG. 10 is a perspective view illustrating a configuration of a part of the fixing-portion main body of the optical unit according to the first embodiment of the disclosure.

FIG. 11 is a perspective view (Part 1) illustrating a configuration of a substrate of the optical unit according to the first embodiment of the disclosure.

FIG. 12 is a perspective view (Part 2) illustrating the configuration of a substrate of the optical unit according to the first embodiment of the disclosure.

FIG. 13 is a perspective view (Part 1) illustrating a configuration of a movable portion of the optical unit according to the first embodiment of the disclosure.

FIG. 14 is a perspective view (Part 2) illustrating the configuration of the movable portion of the optical unit according to the first embodiment of the disclosure.

FIG. 15 is a perspective view (Part 3) illustrating the configuration of the movable portion of the optical unit according to the first embodiment of the disclosure.

FIG. 16 is a cross-section of the optical unit according to the first embodiment of the disclosure.

FIG. 17 is a diagram explaining about movement of each ball and the center of gravity of the movable portion.

FIG. 18 is a diagram exclusively illustrating a configuration of a voice coil motor on a cross-section cut on a plane passing through an axis C, and parallel to the axis C.

FIG. 19 is a diagram for explaining a load on the optical unit according to the first embodiment of the disclosure.

FIG. 20 is a diagram for explaining a positional relationship between respective balls and a biasing force.

FIG. 21 is a front view of the optical unit according to the first embodiment of the disclosure.

FIG. 22 is a partial cross-section of a stopper of an optical unit according to a first modification.

FIG. 23 is a partial cross-section of a stopper of an optical unit according to a second modification.

FIG. 24 is a diagram illustrating a configuration of an endoscope system that includes an endoscope according to a second embodiment of the disclosure.

### DETAILED DESCRIPTION

Hereinafter, embodiments of an optical unit and an endoscope according to the disclosure will be explained with reference to the drawings. Note that these embodiments are not intended to limit the disclosure. The disclosure can be applied to general optical units and endoscopes.

Moreover, in description of the drawings, identical reference symbols are assigned to identical or corresponding elements as appropriate. Moreover, the drawings are only schematic illustration, and it should be noted that dimensions and ratios of the components may differ from an actual situation. There may be differences in relationships and ratios of dimensions even among the drawings.

### First Embodiment

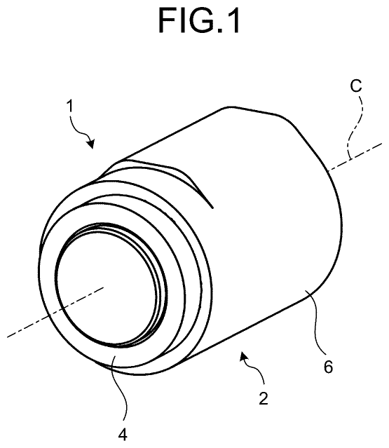

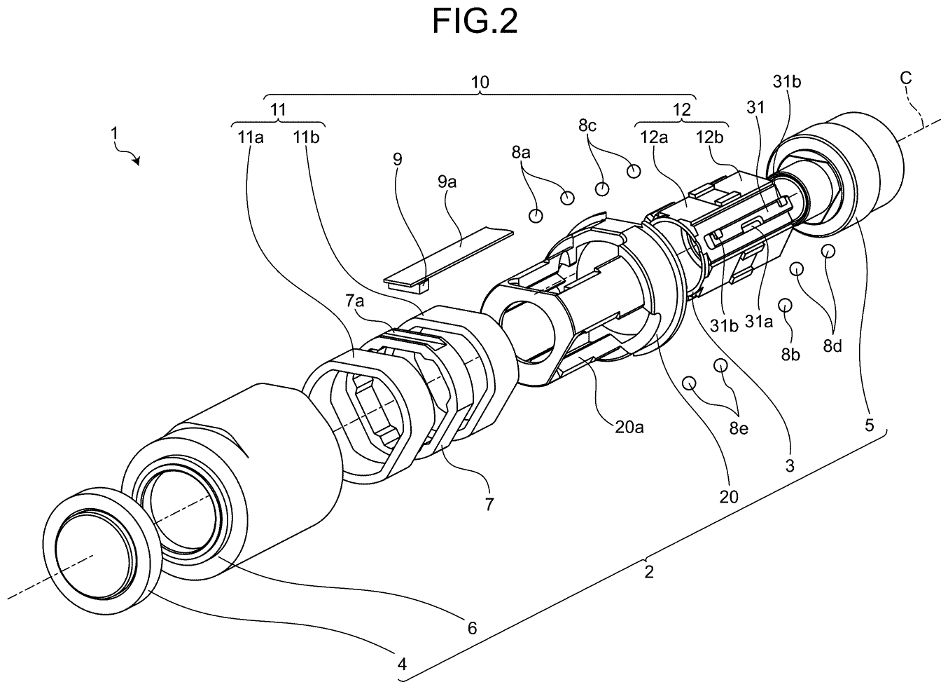

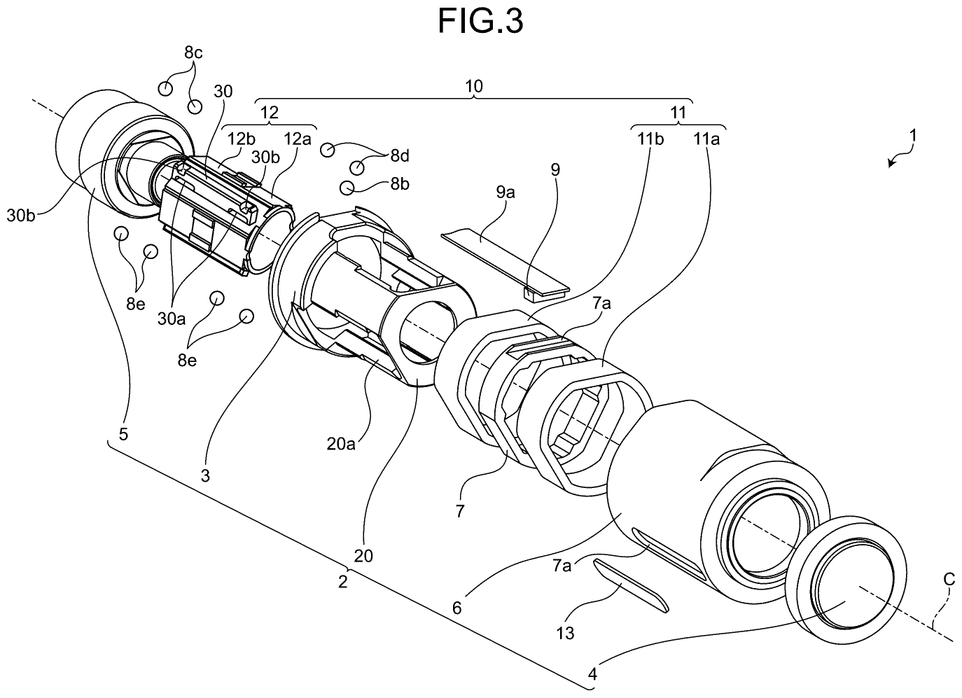

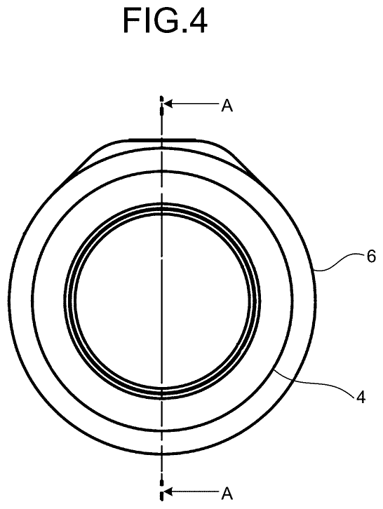

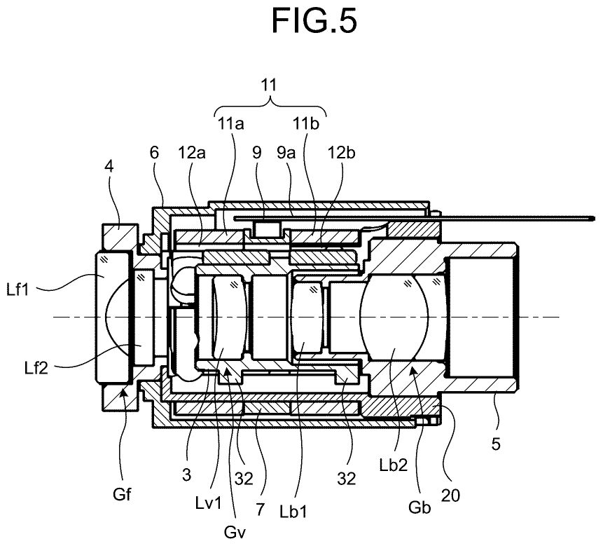

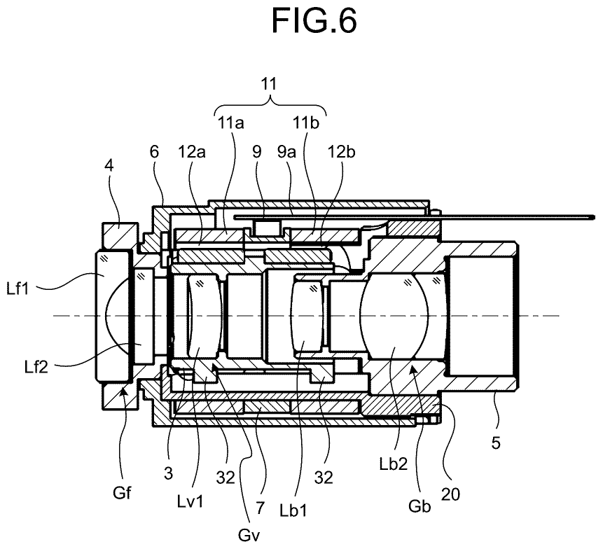

FIG. 1 is a perspective view illustrating a configuration of an optical unit according to a first embodiment of the disclosure. FIG. 2 and FIG. 3 are exploded perspective views illustrating the configuration of the optical unit according to the first embodiment of the disclosure. FIG. 4 is a plan view illustrating the configuration of the optical unit according to the first embodiment of the disclosure. FIG. 5 and FIG. 6 are an A-A cross-section of the optical unit illustrated in FIG. 4. FIG. 5 illustrates an example when a movable portion 3 can be moving toward an image. FIG. 6 illustrates an example when the movable portion 3 can be moving toward an object.

An optical unit 1 includes a fixing portion (lens unit) 2, the movable portion 3 that can move with respect to the fixing portion 2, and a voice coil motor 10 that generates a driving force to move the movable portion 3 with respect to the fixing portion 2. In the following, an example in which an axis C passing through the optical unit 1 coincides with an optical axis of the optical unit 1 will be explained. Hereinafter, an opposite side to an object side in a direction of the axis C can be referred to as image side. In the optical unit 1 illustrated in FIG. 1, the left side can be the object side, and the right side can be the image side. Moreover, a center axis of each member may also be referred to as axis C also. This is because the center axis of the member coincides with the axis C when assembled.

The fixing portion 2 includes a fixing-portion main body (frame) 20, a front frame portion 4 that can be attached to the object side of the fixing-portion main body 20, and that holds an object-side fixing-lens group Gf positioned on the object side relative to a movable lens group Gv held by the movable portion 3, a rear frame portion 5 that can be attached to the image side of the fixing-portion main body 20, and that holds an image-side fixing-lens group (fixed lens) Gb positioned on the image side relative to the movable lens group (movable lens), and a housing portion 6 that houses the fixing-portion main body 20, the movable portion 3, and the rear frame portion 5.

The optical unit 1 can comprise the lens unit including the fixed lens Gb and the movable lens, the frame 20, the movable portion 3 located inside the frame 20, the first slider 8a slidably arranged in a space between the frame 20 and the movable portion 3, and stopper (8c, 8d, 8e) arranged in the space. The fixed lens Gb can be located in a distal section of the frame 20. The movable lens can be located in the movable portion 3 and the movable portion 3 can be movable relative to the frame 20 along an optical axis of the optical unit 1 between a biased state and an unbiased state. The stopper (8c, 8d, 8e) can be made of a non-metal material. In the biased state, the stopper (8c, 8d, 8e) can be spaced apart from the frame 20, and in the unbiased state, the stopper (8c, 8d, 8e) contacts the frame 20.

The movable portion 3 can be in a first position in the biased state, and in a second position in the unbiased state. The first position can be closer to the distal section of the frame 20 than the second position. The movable portion 3 can contact the frame 20 in the biased state, and the movable portion 3 can be spaced apart from the frame 20 in the unbiased state.

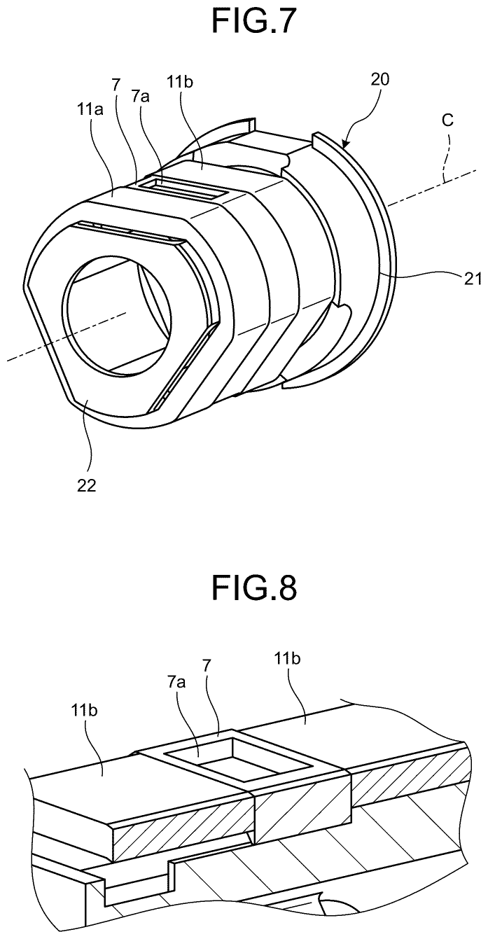

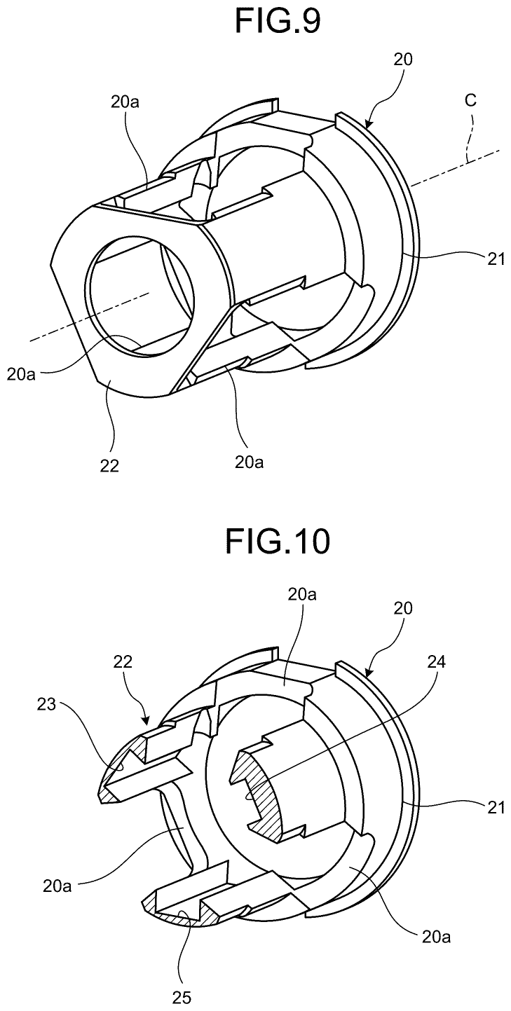

FIG. 7 is a perspective view illustrating a configuration of the fixing-portion main body of the optical unit according to the first embodiment of the disclosure. FIG. 8 is an enlarged view of a part of the fixing-portion main body of the optical unit according to the first embodiment of the disclosure. FIG. 9 is a perspective view illustrating the configuration of the fixing-portion main body of the optical unit according to the first embodiment of the disclosure. FIG. 10 is a perspective view illustrating the configuration of a part of the fixing-portion main body of the optical unit according to the first embodiment of the disclosure. The fixing-portion main body 20 is made of a cylindrical shape member, and the axis C passes through a center inside the cylinder portion. The fixing-portion main body 20 includes a first cylindrical portion 21, the center axis of can be the axis C, and a second cylindrical portion 22 that extends in the direction of the axis C from one end of the first cylindrical portion 21.

The first cylindrical portion 21 has a stepped shape in which an end portion of an outer peripheral portion on the image side protrudes. The first cylindrical portion 21 can be partially housed in the housing portion 6, and abuts on the housing portion 6 on the stepped portion.

The second cylindrical portion 22 has a cylindrical shape with a diameter of an outer periphery smaller than a diameter of an outer periphery of the first cylindrical portion 21. On a side surface of the second cylindrical portion 22, three through holes 20a piercing therethrough in a direction perpendicular to the axis C (a radial direction) can be formed (refer to FIG. 9). On an inner peripheral surface of the second cylindrical portion 22, three rails (rails 23 to 25) that extend in the direction of the axis C can be formed (refer to FIG. 10). The through holes 20a and the rails 23 to 25 can be formed respectively at regular intervals of 120° along a circumferential direction on a cross-section cut on a plane perpendicular to the axis C. The through holes 20a and the rails 23 to 25 can be alternately arranged in a circumferential direction of the second cylindrical portion 22. Each of the rails 23 to 25 can be positioned to face the through hole 20a through the axis C.

Moreover, a ring-shaped portion 7 that surrounds an outer periphery of the second cylindrical portion 22 can be arranged at a central portion of the second cylindrical portion 22 in the direction of the axis C (refer to FIG. 7). At a portion of an outer periphery of the ring-shaped portion 7, a housing groove 7a in a concave shape can be formed. In the housing groove 7a, a detecting device 9 that outputs a detection signal to detect a position of the movable portion 3 can be arranged. With the arrangement of the detecting device 9 in the housing groove 7a, the detecting device 9 can be positioned between a first coil 11 and a second coil 11b described later in the direction of the axis C. The detecting device 9 can be connected to a substrate 9a. The substrate 9a can be connected to a control board (not illustrated) that performs position detection. The detecting device 9 can be constituted of, for example, a magnetic sensor. The magnetic sensor can be implemented by using, for example, Hall elements and magnetoresistive (MR) elements. The magnetic sensor can be housed and fixed inside the housing groove 7a. Based on a detection signal detected by the magnetic sensor, the position of the movable portion 3 can be detected accurately. The detection signal pertains to magnetism of the magnet 12, and includes information such as a magnetic field direction and a magnetic field strength.

The front frame portion 4 holds the object-side fixing-lens group Gf. The object-side fixing-lens group Gf can be constituted of multiple lenses including an objective lens Lf1 (in this example, the objective lens Lf1 and a lens Lf2) aligned in the direction of the axis C.

The rear frame portion 5 holds the image-side fixing-lens group Gb. The image-side fixing-lens group Gb includes multiple lenses (lenses Lb1, Lb2) aligned in the direction of the axis C.

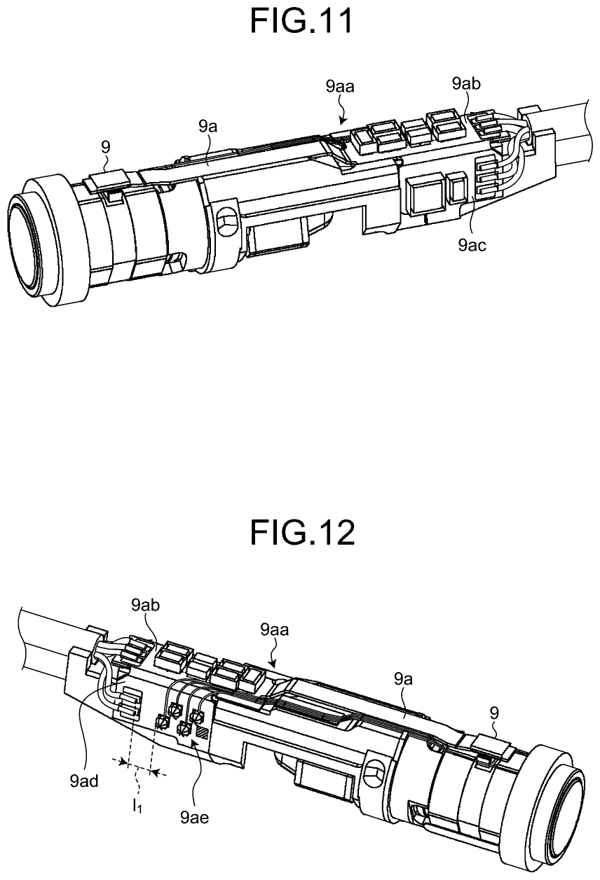

FIGS. 11, 12 are a perspective view illustrating a configuration of a substrate of the optical unit according to the first embodiment of the disclosure. On a proximal end side of the substrate 9a, a stepped portion 9aa that can be bend by a height of a part mounted toward an inner side in a radial direction can be formed. With the stepped portion 9aa formed therein, space on a proximal end side of an imaging device can be used effectively, and the diameter of the optical unit 1 can be reduced.

The proximal end side of the substrate 9a can be constituted of a first mounting surface 9ab that extends toward the proximal end side parallel to a surface on which the detecting device 9 can be arranged, a second mounting surface 9ac and a third mounting surface 9ad that intersect the first mounting surface 9ab. With the second mounting surface 9ac and the third mounting surface 9ad intersecting the first mounting surface 9ab, respective devices can be mounted on the second mounting surface 9ac and the third mounting surface 9ad. Therefore, a length of the substrate 9a in the direction of the axis C can be shortened, and a length of a hard portion of the optical unit 1 can be shortened. A boundary portion between the first mounting surface 9ab and the second mounting surface 9ac, and a boundary portion between the first mounting surface 9ab and the third mounting surface 9ad can be not provided with a reinforcing member for reinforcing the substrate 9a, or can be formed as a thin portion, providing a bendable structure.

On the third mounting surface 9ad, a connecting portion 9ae to connect a coil wire to a wiring on the substrate 9a by soldering can be formed. This enables to bring a position of soldering on the proximal end side, and improves workability of soldering compared to a case when soldering can be performed near the detecting device 9.

An example in which both sides of the first mounting surface 9ab can be bent to form two mounting surfaces of the second mounting surface 9ac and the third mounting surface 9ad has been explained herein, but it can be not limited thereto. A mounting surface intersecting the first mounting surface may be one, or may be three or more. Furthermore, multiple mounting surface may be formed on one side of the first mounting surface. Moreover, not only by forming a mounting surface to create folds along axis C, but also by bending it to create folds in directions perpendicular to or intersecting with the axis C, an area on which various devices can be mounted may be increased. Furthermore, a widened portion can be formed on the proximal end side of the substrate 9a, and by curving this widened portion in an arc shape, the area on which various devices can be mounted may be increased. Moreover, various kinds of elements may be mounted on the inner periphery side, not on the outer periphery side of the substrate 9a.

Furthermore, the outer peripheral portions of the first mounting surface 9ab, the second mounting surface 9ac, and the third mounting surface 9ad can be sealed with an adhesive or a heat-shrinkable tube in a watertight manner. As a result, the outer periphery can be covered more tightly compared to a case in which a metal material can be used for covering. Therefore, it can be possible to reduce the diameter of the optical unit 1, and the length of the hard portion of the optical unit 1 can be reduced.

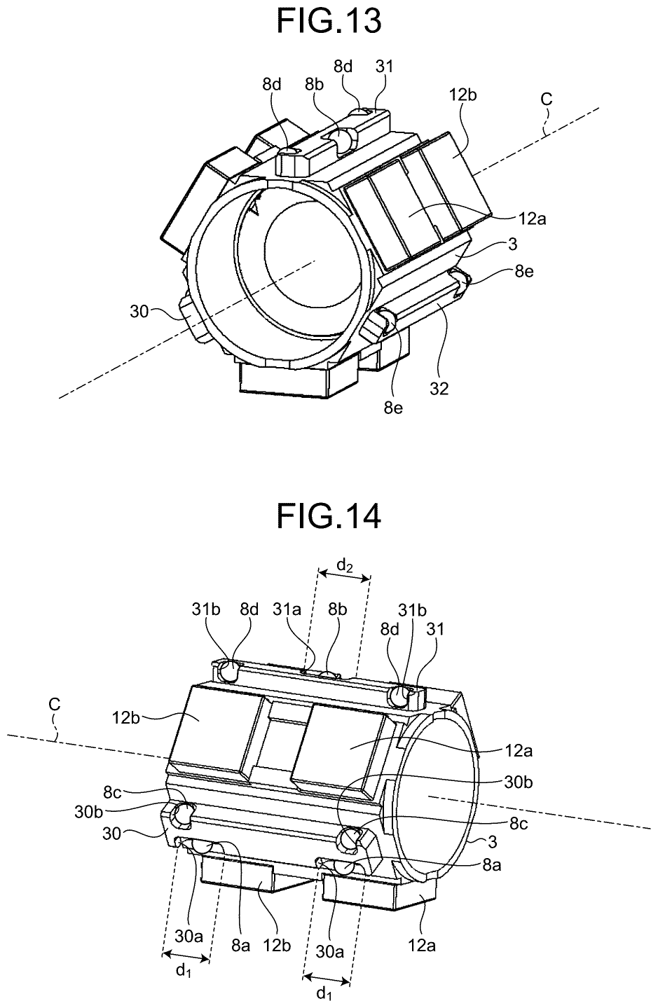

FIG. 13 to FIG. 15 are perspective views illustrating a configuration of the movable portion of the optical unit according to the first embodiment of the disclosure. The movable portion 3 can be constituted of a member in a cylindrical shape, an outer edge of which forms a hexagonal shape when viewed from the direction of the axis C. The movable portion 3 holds the movable lens group Gv. The movable lens group Gv can be constituted of, for example, one or more lenses (a lens Lv1 in this example) aligned in the direction of the axis C.

The movable portion 3 includes a first protrusion 30, a second protrusion 31, and a third protrusion 32 that can be arranged on an outer surface, and that protrude outward. The first protrusion 30, the second protrusion 31, and the third protrusion 32 can be arranged on surfaces different from one another and that can be not adjacent to one another, out of six surfaces constituting the outer surface of the movable portion 3. That is, the first protrusion 30, the second protrusion 31, and the third protrusion 32 can be arranged with one face gap on the six surfaces constituting the outer surface of the movable portion 3.

The first protrusion 30 can be housed in the rail 23 when assembled in the optical unit 1. The first protrusion 30 has concave portions 30a, 30b. The concave portion 30a has a groove shape with one end in the circumferential direction being open. The concave portion 30b can be arranged on the opposite side to the concave portion 30a in the circumferential direction of the movable portion 3, and has a groove shape with one end in the circumferential direction of the movable portion 3 being open. The first protrusion 30 extends along the direction of the axis C.

The second protrusion 31 can be housed in the rail 24 when assembled in the optical unit 1. The second protrusion 31 has concave portions 31a, 31b. The concave portion 31a has a groove shape with one end in the circumferential direction being open. The concave portion 31b can be arranged on the opposite side to the concave portion 31a in the circumferential direction of the movable portion 3, and has a groove shape with one end in the circumferential direction of the movable portion 3 being open. The second protrusion 31 extends along the direction of the axis C. The movable portion 3 can have the protrusion 31, the protrusion 31 can have a first recess 31a and a second recces 31b configured to respectively house the first slider 8a and the stopper (8c, 8d, 8e). The first recess 31a can have a first length in a direction of the optical axis. The second recess 31b can have a second length in the direction of the optical axis. The first length can be larger than the second length.

A distance d1 in the direction of the axis C of the concave portion 30a can be set to be equal to or larger than a moving distance of the movable portion 3.

Moreover, a distance d2 in the direction of the axis C of the concave portion 31a can be set to be equal to or larger than a moving distance of the movable portion 3.

The distances d1 and d2 may be the same, or may be different distances from each other as long as they can be set to be equal to or larger than the moving distance.

The third protrusion 32 can be housed in the rail 25 when assembled in the optical unit 1. The third protrusion 32 has a concave portion 32a. The concave portion 32a has a groove shape with one end in the circumferential direction of the movable portion 3 being open. The third protrusion 32 extends along the direction of the axis C.

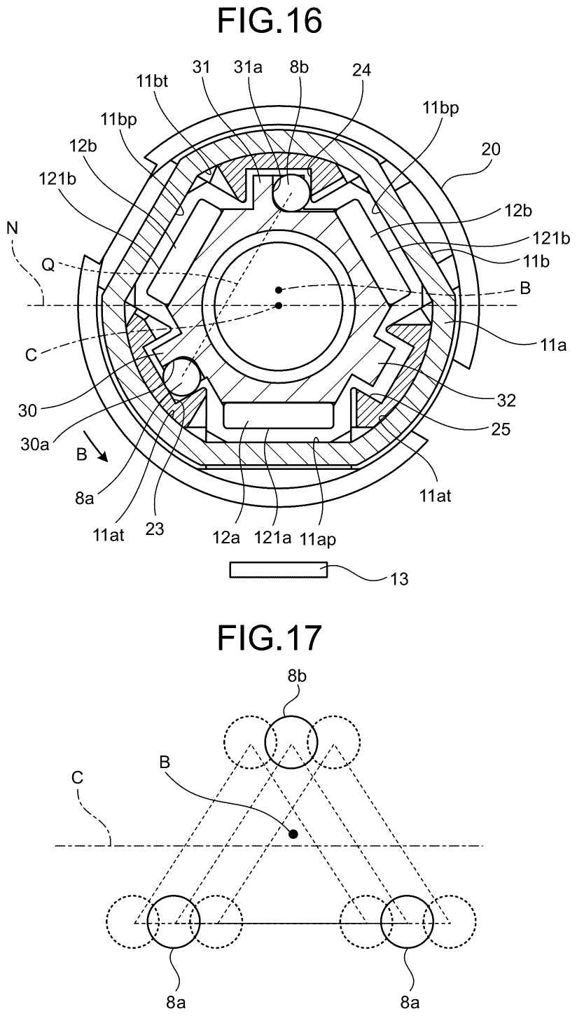

FIG. 16 is a cross-section of the optical unit according to the first embodiment of the disclosure. FIG. 16 illustrates cross-sections of cutting planes different from each other with an axis N, can be perpendicular to the axis C, as a boundary.

Between each of the concave portions 30a and the rail 23, a first ball (first slider) 8a can be present. A first ball 8a housed in one of the concave portions 30a corresponds to a first slider, and the first ball 8a housed in the other concave portion 30a corresponds to a third slider.

Moreover, between the concave portion 31a and the rail 24, a second ball 8b can be present. The second ball 8b housed in the concave portion 31a corresponds to a second slider.

The first balls 8a and the second ball 8b have a spherical shape, and can be made of, for example, a ceramic material, such as zirconia. The first balls 8a and the second ball 8b can be made of a non-metal material, such as ceramic, but may also be made of a metal or an alloy. The second slider 8b can be slidably arranged in the space between the frame 20 and the movable portion 3. The second slider can be configured to slidably move along with a movement of the movable portion 3. The stopper (8c, 8d, 8e) can be arranged on an opposite side of the movable portion 3 from the first slider 8a and the second slider 8b.

In a state in which the movable portion 3 can be housed in the fixing-portion main body 20, the respective first balls 8a can be sandwiched between the concave portion 30a and the rail 23 of the second cylindrical portion 22. At this time, one of the first ball 8a abuts on a wall surface of the rail 23, and the other first ball 8a also abuts on a wall surface of the rail 23.

The third protrusion 32 can be positioned in the rail 25 in a state in which the movable portion 3 can be housed in the fixing-portion main body 20.

Subsequently, a configuration of the voice coil motor 10 will be explained. The voice coil motor 10 includes the coil 11 arranged in the fixing-portion main body 20 of the fixing portion 2, and the magnet 12 arranged in the movable portion 3 facing the coil 11 (for example, refer to FIG. 2, FIG. 3, and FIG. 16). The voice coil motor 10 functions as a driver (actuator). The actuator can include 10 the coil 11 and a first magnet unit 12, the actuator 10 can be configured to move the movable portion 3 relative to the frame 20 in a direction of the optical axis. The first magnet unit 12 can include three sets of magnets 12, each set of magnets 20 can include a first magnet and a second magnet arranged on different outer peripheral surfaces of the movable portion 3. In each set of magnets, the first magnet and the second magnet can be respectively magnetized in a radial direction of the movable direction, and magnetic poles of the first magnet and the second magnet face in opposite directions.

The coil 11 includes a first coil 11a that can be wound around the outer periphery of the second cylindrical portion 22 of the fixing-portion main body 20, and a second coil 11b that can be arranged aligned in the direction of the axis C of the first coil 11a, and that can be wound around the outer periphery of the second cylindrical portion 22 of the fixing-portion main body 20 (for example, refer to FIG. 7). Between the first coil 11a and the second coil 11b, the ring-shaped portion 7 can be arranged. The coil 11 may be pre-wound and placed afterward. The first coil 11a and the second coil 11b adjacent to each other in the direction of the axis C can be electrically connected in series, but may also be connected in parallel.

The first coil 11a and the second coil 11b have flat surface portions 11ap and 11bp facing the through hole 20a of the fixing-portion main body 20, respectively. Moreover, the first coil 11a and the second coil 11b have circular cylindrical portions 11at and 11bt facing the second cylindrical portion 22, respectively. The first coil 11a has a form in which the three flat surface portions 11ap and the three circular cylindrical portions 11bt can be alternately arranged on a cross-section perpendicular to the axis C. Similarly, the second coil 11b has a form in which the three flat surfaces 11bp and the three circular cylindrical portions 11bt can be alternately arranged on a cross-section perpendicular to the axis C.

The magnet 12 has three sets of flat first magnets 12a and flat second magnets 12b facing the flat surface portions 11ap and 11bp, respectively inside the flat surface portion 11ap of the first coil 11a and the flat surface portion 11bp of the second coil 11b, and that can be aligned in the direction of the axis C. The three sets of the first magnets 12a and the second magnets 12b can be arranged at regular intervals of 120° along a circumferential direction on a cross-section cut on a plane perpendicular to the axis C. By arranging the respective sets of the magnets at regular intervals, the first magnets 12a and the second magnets 12b can be arranged stably. As a result, a stable magnetic field can be formed in the voice coil motor 10, and it becomes possible to suppress wobble of the movable portion 3 that moves relative to the fixing portion 2. Although the magnets 12 can be arranged around the axis C at 120° intervals in the first embodiment, the magnets 12 may be arranged at intervals of other angles.

At total width in the direction of the axis C of the first magnets 12a and the second magnets 12b can be shorter than a total width in the direction of the axis C of the first coil 11a and the second coil 11b. By satisfying this condition, it can be possible to make the first magnet 12a and the second magnet 12b be present within a width of the first coil 11a and the second coil 11b in the direction of the axis C within a moving range of the movable portion 3.

FIG. 17 is a diagram explaining about movement of each ball and the center of gravity of the movable portion. FIG. 17 illustrates an example of arrangement of each ball after movement of the movable portion 3, can be arrangement of each ball viewed from a direction perpendicular to the axis C, and to a line segment (for example, a line segment Q in FIG. 16) connecting the center of gravity of the first ball 8a and the center of gravity of the second ball 8b (for example, a direction toward the axis C from an upper left side of FIG. 16). FIG. 17 illustrates balls (solid line) positioned in the center of the moving range of the movable portion 3, and balls (broken line) at positions when the movable portion 3 has moved to the image side and the object side from the center. The two first balls 8a and the second ball 8b can be arranged in such a manner that the center B of gravity of the movable portion 3 can be located within a triangle formed by connecting the centers of gravity of the respective first balls 8a and the center of gravity of the second ball 8b regardless of the position of the movable portion 3. The first slider 8a includes a first sub-slider 8a and a second sub-slider 8a. The first sub-slider 8a can be spaced apart from the second sub-slider 8a in a direction of the optical axis. The first sub-slider 8a, the second sub-slider 8a, and the second slider 8a can be arranged such that a center of gravity of the movable portion 3 can be located within a triangle formed by connecting centers of gravity of the first sub-slider 8a, the second sub-slider 8a, and the second slider 8b.

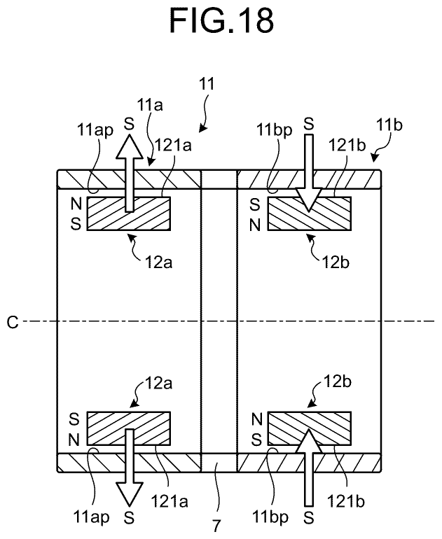

FIG. 18 is a diagram exclusively illustrating a configuration of the voice coil motor on a cross-section cut on a plane passing through the axis C and parallel to the axis C. FIG. 18 illustrates different cross-sections with the axis C as a boundary. The first magnet 12a and the second magnet 12b that form a pair in the direction of the axis C can be arranged apart from each other. The pair of the first magnet 12a and the second magnet 12b can be magnetized in the radial direction, and the magnetic poles face in opposite directions. In the case illustrated in FIG. 18, the first magnet 12a has the north pole on the first coil 11a side and the south pole on the opposite side, while the second magnet 12b has the south pole on the second coil 11b side and the north pole on the opposite side. In this case, the direction of magnetic polarization of the first magnet 12a and the second magnet 12b can be perpendicular to the axis C (refer to an outline arrow S in FIG. 18). More generally speaking, the direction of magnetic polarization of the first magnets 12a and the second magnet 12b may be a direction perpendicular to the axis C.

In the first embodiment, the winding direction can be reversed between the pair of the first magnets 12a and the second magnet 12b. For example, when the first coil 11a can be wound in a direction of an arrow B, the second coil 11b can be wound in an opposite direction. Alternatively, it can be also acceptable that the winding directions of the first coil 11a and the second coil 11b can be identical and the first coil 11a and the second coil 11b can be connected with the current directions reversed. In this case, when an electric current can be flowed in the direction of the arrow B in FIG. 13 to the first coil 11a, an electric current in a reversed direction to the arrow B can be flowed to the second coil 11b.

Moreover, outside the housing portion 6, a housing groove 6a can be formed. In the housing groove 6a, a magnetic body (second magnet unit) 13, can be a biasing portion, can be provided. The magnetic body 13 attracts the magnet 12 with its magnetic force, thereby creating a biased state in which the movable portion 3 can be drawn toward the fixing-portion main body 20. The biasing portion can be not limited thereto, and it can be only necessary to draw the movable portion 3 toward the fixing-portion main body 20. For example, it may be a metal, such as iron. Furthermore, the biasing portion may be configured to draw the movable portion 3 toward the fixing-portion main body 20 by applying a biasing force in a direction in which the magnet 12 moves apart from the biasing portion. The second magnet unit 13 can be arranged radially outside the movable portion 3, the second magnet unit 13 can be configured to cause the first magnet unit 12 to generate a magnetic force that places the movable portion 3 in the biased state. The first slider 8a can be located where a rotational moment around the first slider 8a can be generated in the movable portion 3 by the magnetic force.

In a state in which the movable portion 3 can be housed in the fixing-portion main body 20, the movable portion 3 and the fixing-portion main body 20 can be not in direct contact with each other, and have a relative positional relationship viewed from the direction of the axis C that the positions of the movable portion 3 and the fixing-portion main body 20 can be fixed through the two first balls 8a and the second ball 8b.

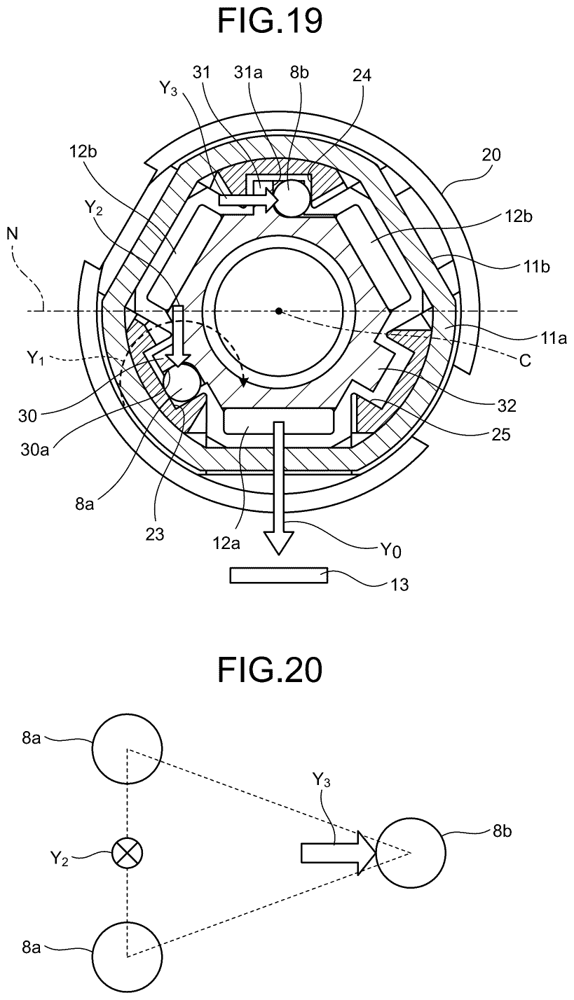

FIG. 19 is a diagram for explaining a load on the optical unit according to the first embodiment of the disclosure. FIG. 19 illustrates cross-sections of different cut planes with an axis N perpendicular to the axis C as a boundary, similarly to FIG. 16. In the optical unit 1, the magnet 12 (the first magnet 12a in FIG. 19) receives a biasing force Y₀ by a magnetic force of the magnetic body 13, toward be attracted to the magnetic body 13. With this attraction, to the movable portion 3, a rotational moment Y₁ around the first ball 8a can be applied. At this time, to the movable portion 3, a pressing force Y₂ of the first protrusion 30 pushing the first ball 8a toward the rail 23 can be applied, and a pressing force Y₃ of the second protrusion 31 pushing the second ball 8b toward the rail 24 can be also applied.

FIG. 20 is a diagram for explaining a positional relationship between the respective balls and the biasing force. FIG. 20 is a diagram illustrating an example of the positional relationship between the two first balls 8a and the second ball 8b projected in a direction of the biasing force Y₀ on a plane parallel to the axis N and passing through the axis C. In a triangle (broken line in FIG. 20) formed by line segments connecting the centers of gravity of the two first balls 8a and the second ball 8b, only a component perpendicular to the biasing force Y₀ (only the pressing force Y₃) can be applied to the second ball 8b. Therefore, the biasing force Y₀ can be to be applied from a position on a line segment (broken line) between the first balls 8a to the respective first balls 8a. The component ratio of the biasing force Y₀ applied to the respective first balls 8a varies according to a relative position (the position of the movable portion 3) of the respective first balls 8a. By positioning a point of application of the biasing force Y₀ at a central position in the direction of the axis C with respect to the position of the respective first balls 8a, the component ratio of the biasing force Y₀ applied to the respective first balls 8a can be equalized. By applying this pressing force Y₂, a component in the direction of the pressing force Y₂ out of the biasing force Y₀ from the magnetic body 13 can be effectively used, and the position of the movable portion 3 relative to the fixing-portion main body 20 can be stabilized.

In the optical unit 1 having the configuration described above, the movable portion 3 in which the first magnets 12a can be arranged respectively to face the first coil 11a can be arranged inside in the radial direction of the fixing-portion main body 20 in which the first coil 11a can be wound. Therefore, the flat surface portion 11ap of the first coil 11a can be present within a magnetic field in a direction perpendicular to a surface 121a (refer to FIG. 18) outside in the radial direction of the respective first magnets 12a. The second magnet 12b can be also configured in a similar manner. Therefore, it becomes possible to improve the driving efficiency, and to move the movable portion 3 swiftly. Moreover, by forming the surface 121a outside in the radial direction of the first magnet 12a and a surface 121b outside in the radial direction of the second magnet 12b into a flat shape, it can be possible to perform assembly of the optical unit 1 easily.

Moreover, when an electric current can be flowed through the coil 11 of the optical unit 1, a force in the direction of the axis C can be generated in the movable portion 3 affected by the magnetic field of the magnet 12, and the movable portion 3 moves in the direction of the axis C relative to the fixing-portion main body 20. For example, by respectively controlling the electric current to be flowed through the first coil 11a and the second coil 11b, the movable portion 3 can be moved with respect to the fixing portion 2. At this time, along with the movement of the movable portion 3, the first balls 8a and the second ball 8b slide (rotate in this case). By the rotation of the first balls 8a and the second ball 8b, friction between the fixing-portion main body 20 and the movable portion 3 can be reduced. Even in a state in which the movable portion 3 can be moving with respect to the fixing portion 2, the surface outside in the radial direction of the magnet 12 can be arranged inside the through hole 20a of the fixing-portion main body 20. The frame 20 can includes a first and a second rails (23, 24, 25) that guide movement of the first and the second sliders (8a, 8b), and a through passage 20a formed at a position facing the first and the second rails (23, 24, 25) through a center axis C of the frame 20. The through passage 20a can house a part of the magnet unit 12.

Moreover, according to the first embodiment, the first balls 8a and the second ball 8b can be positioned between the fixing portion 2 and the movable portion 3, to move the movable portion 3 relative to the fixing portion 2 by rotation of the balls, thereby enabling to move the movable portion 3 (movable lens) smoothly relative to the fixing portion 2.

Furthermore, according to the first embodiment, because the detecting device (sensor) 9 can be positioned between the first coil 11a and the second coil 11b in the direction of the axis C, an influence of a leakage magnetic field can be reduced, and deterioration of the detecting accuracy due to leakage magnetic field can be suppressed. The influence of leakage magnetic field increases when the detecting device 9 and the magnet 12 (the first magnet 12a or the second magnet 12b) can be separated as a result of movement of the movable portion 3, but the first embodiment adopts the arrangement in which the detecting device 9 can be less susceptible to the influence of leakage magnetic field and, therefore, the detection accuracy can be ensured. Moreover, by arranging the detecting device 9 between the coils, downsizing can be possible compared to when the detecting device 9 can be arranged outside in the radial direction of the coil. The coils 11 can be aligned along the optical axis. The sensor 9 can be configured to output a detection signal to detect a position of the movable portion 3.

Furthermore, according to the first embodiment, by configuring the fixing portion 2 using the fixing-portion main body 20, the front frame portion 4, and the rear frame portion 5, it can be possible to reduce the number of parts and assembly process, and to increase the design flexibility, thereby achieving cost reduction.

Moreover, according to the first embodiment, because the coil 11 can be wound around the axis C as its center, it can be possible to make the sliding axis of the movable portion 3 and the axis of thrust force generated by the voice coil motor 10 coaxial, and stable driving can be enabled.

Furthermore, according to the first embodiment, multiple pieces of the magnet 12 can be arranged symmetrically about the axis C and, therefore, it can be possible to increase the driving force stably.

Moreover, according to the first embodiment, the magnet 12 includes multiple sets of the first magnet 12a and the second magnet 12b that can be adjacent to each other in the direction the axis C, and the magnetic polarization direction, of can be opposite directions. The multiple first magnets 12a have the same magnetic polarization direction. The coil 11 includes the first coil 11a facing the multiple first magnets 12a and the second coil 11b facing the multiple second magnets 12b and being connected to the first coil 11a, and because the directions in which the current flows in the first coil 11a and the second coil 11b can be opposite, the driving force can be increased.

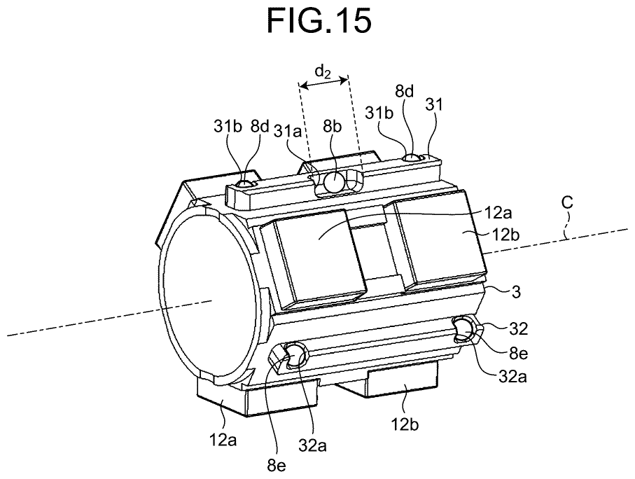

FIG. 21 is a front view of the optical unit according to the first embodiment of the disclosure. FIG. 21 illustrates the optical unit 1 viewed from the object side in the axis C. Between each of the concave portions 30b (refer to FIG. 14) and the rail 23, a third ball 8c can be present. Between each of the concave portions 31b (refer to FIG. 14) and the rail 24, a fourth ball 8d can be present. Between each of the concave portions 32a (refer to FIG. 15) and the rail 25, a fifth ball 8e can be present. The third ball 8c, the fourth ball 8d, and the fifth ball 8e correspond to a stopper.

The third ball 8c, the fourth ball 8d, and the fifth ball 8e can be arranged between the concave portions 30b, 31b, 32a of the movable portion 3, and the rails 23 to 25 of the fixing portion 2. The third ball 8c, the fourth ball 8d, and the fifth ball 8e have a spherical shape, and can be made of ceramic, such as zirconia. The third ball 8c, the fourth ball 8d, and the fifth ball 8e can be made of a non-metal material, such as ceramic, but may be made of a metal or an alloy. The third ball 8c, the fourth ball 8d, and the fifth ball 8e can have the same shape and be made of the same material as the first ball 8a and the second ball 8b.

Moreover, the third ball 8c, the fourth ball 8d, and the fifth ball 8e can be arranged on the opposite side of the first ball 8a and the second ball 8b across the first protrusion 30, the second protrusion 31, and the third protrusion 32 of the movable portion 3 in the circumferential direction of the movable portion 3. As a result, the third ball 8c, the fourth ball 8d, and the fifth ball 8e can be separated from the rails 23 to 25 of the fixing portion 2 in the biased state in which the movable portion 3 can be drawn toward the fixing portion 2, and come into contact with the rails 23 to 25 of the fixing portion 2 in a state in which the biased state can be released.

Furthermore, the third ball 8c, the fourth ball 8d, and the fifth ball 8e can be arranged on both ends of the movable portion 3 in the direction in which the movable portion 3 moves (refer to FIGS. 14, 15).

In the optical unit 1 with the configuration described above, because the third ball 8c, the fourth ball 8d, and the fifth ball 8e made of a non-metal material come into contact with the rails 23 to 25 of the fixing portion 2 in the state in which the biased state can be released, contact between the first protrusion 30, the second protrusion 31, and the third protrusion 32 and the rails 23 to 25, can be both metal parts, can be prevented, and deterioration in the sliding performance can be prevented.

Furthermore, according to the first embodiment, because the third ball 8c, the fourth ball 8d, and the fifth ball 8e have the same shape, and can be made of the same material as the first ball 8a and the second ball 8b, it can be not necessary to distinguish, to make the assembly easy, and the number of types of parts can be decreased, to reduce the manufacturing cost. The same shape and the same material include a design error.

Moreover, according to the first embodiment, because the third ball 8c, the fourth ball 8d, and the fifth ball 8e can be formed in a spherical shape, the third ball 8c, the fourth ball 8d, and the fifth ball 8e rotate to prevent the components from rubbing against each other, thereby preventing deterioration of the sliding performance. In a direction of movement of the movable portion 3, the stopper (8c, 8d, 8e) can be arranged on both sides of the movable portion 3. the stopper (8c, 8d, 8e) can include a first sub-stopper and a second sub-stopper, the first sub-stopper can be provided distally relative to the first slider 8a in a direction of the optical axis, the second sub-stopper can be provided proximally relative to the first slider 8a in the direction of the optical axis. The first slider 8a can be located at a first position in a direction of the optical axis, the stopper (8c, 8d, 8e) can be located at a second position in the direction of the optical axis. The first slider can be distally located relative to the stopper (8c, 8d, 8e) in a direction of the optical axis.

Furthermore, according to the first embodiment, because the third ball 8c, the fourth ball 8d, and the fifth ball 8e can be arranged on both sides of the movable portion 3 in the direction in which the movable portion 3 moves, and the slope of the movable portion 3 from the axis C can be set to be small, and it can be possible to prevent the components from interfering with each other.

### First Modification

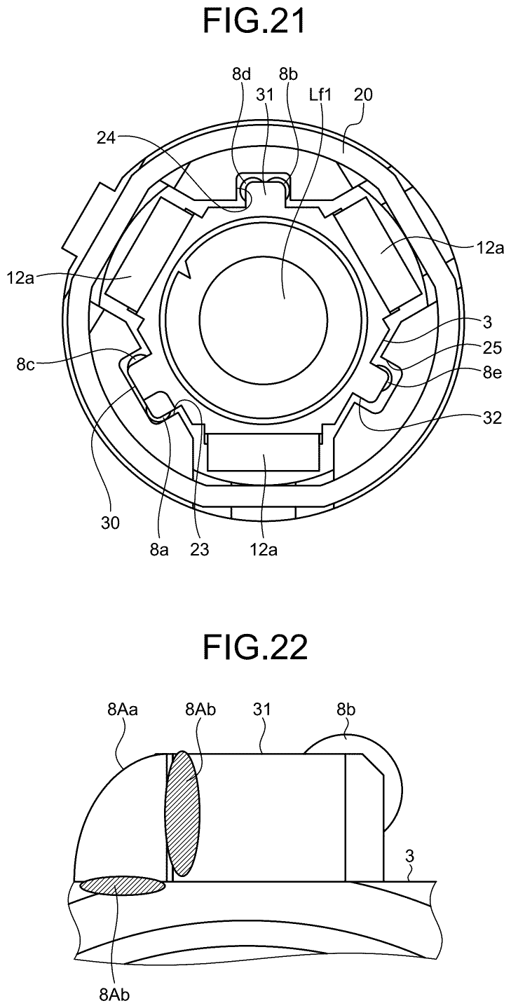

FIG. 22 is a partial cross-section of a stopper of an optical unit according to a first modification. In the optical unit according to the first modification, between the second protrusion 31 and the rail 24, a stopper 8Aa made of, for example, resin, can be arranged. The stopper 8Aa can be fixed to the movable portion 3 with an adhesive 8Ab. A similar configuration can be adopted between the first protrusion 30 and the rail 23, and between the third protrusion 32 and the rail 25 also. As described, the shape of the stopper may be shapes other than a spherical shape. The stopper (8c, 8d, 8e) can have a shape identical to the first slider 8a. The stopper can be a ball bearing. The stopper (8c, 8d, 8e) and the first slider 8a can be made of a first material. The first material can be a resin or a ceramic.

In the optical unit 1 according to the first modification having the configuration described above, because the stopper 8Aa made of resin comes in contact with the rail 24 of the fixing portion 2 in the state in which the biasing state can be released, contact between the second protrusion 31 and the rail 24, can be both metal parts, can be prevented, and the deterioration of the sliding performance can be prevented.

The stopper 8Aa may be fixed to the movable portion 3 by diffusion bonding. Similarly, the stopper 8Aa may be formed by insert molding.

### Second Modification

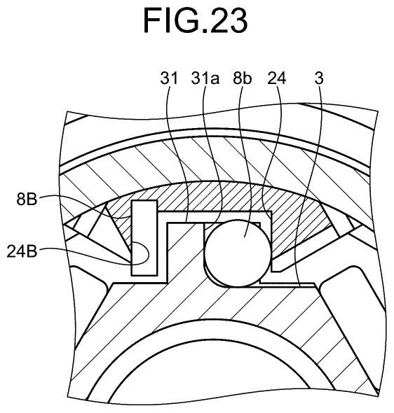

FIG. 23 is a partial cross-section of a stopper of an optical unit according to a second modification. In the optical unit according to the second modification, a stopper 8B made of, for example, resin can be arranged between the second protrusion 31 and the rail 24. The stopper 8B can be fixed to the fixing portion 2. A similar configuration can be adopted between the first protrusion 30 and the rail 23, and between the third protrusion 32 and the rail 25. As described, the stopper may be fixed to the fixing portion 2.

In the optical unit 1 according to the second modification with the configuration described above, because the stopper 8B made of resin comes in contact with the rail 24 of the fixing portion 2 in the state in which the biased state can be released, contact between the second protrusion 31 and the rail 24, can be both metal parts, can be prevented, and deterioration of the sliding performance can be prevented.

Moreover, deterioration of the sliding performance due to contact between metal components may be prevented by forming at least one of the fixing portion 2 and the movable portion 3 with resin. Similarly, deterioration of the sliding performance due to contact between metal components may be prevented by coating at least one of the fixing portion 2 and the movable portion 3 with resin or the like. Furthermore, deterioration of the sliding performance may be prevented by applying lubricant between the stopper and the fixing portion 2 or the movable portion 3. When the stopper can be in a spherical shape, deterioration of the sliding performance may further be prevented by applying lubricant.

### Second Embodiment

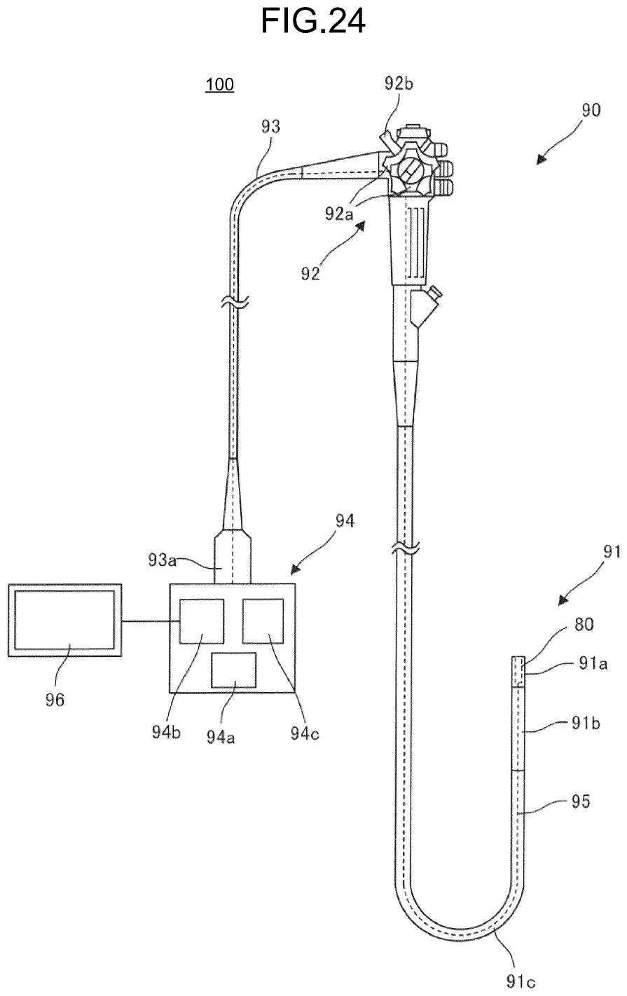

FIG. 24 is a diagram illustrating a configuration of an endoscope system that includes an endoscope according to a second embodiment of the disclosure. An endoscope system 100 illustrated in the figure includes an endoscope 90, a control device 94, and a display device 96. The endoscope 90 includes the optical unit 1 described above. The second embodiment will be explained assuming that, for example, the optical unit 1 according to the first embodiment can be included.

The endoscope 90 can be inserted into a body of a subject, such as a human body, and optically captures an image of a predetermined observation site in the body of a subject. The subject in which the endoscope 90 can be inserted can be not limited to a human body, but may be other living organisms, or artificial objects such as machinery and structures. In other words, the endoscope 90 may be a medical endoscope or an industrial endoscope.

The endoscope 90 includes an insertion portion 91 that can be inserted into the inside of the subject, an operating unit 92 that can be positioned at a proximal end of the insertion portion 91, and a universal cord 93 as a composite cable extending from the operating unit 92. The endoscope 90 can insert into an inside of a subject to observe an inside of the subject. The endoscope can comprise the optical unit 1, an imaging device configured to convert light guided by the optical unit into an electrical signal, a controller (at least one processor) configured to control driving of the optical unit 1.

The insertion portion 91 includes a distal end portion 91a arranged at its distal end, a bendable portion 91b that can be arranged on a proximal end side of the distal end portion 91a, and a flexible tube portion 91c that can be arranged on the proximal end side of the bendable portion 91b, that can be connected to a distal end side of the operating unit 92, and that has flexibility. In the distal end portion 91a, an imaging unit 80 that captures an image of a subject by collecting light from the subject can be arranged. The imaging unit 80 includes the optical unit 1 that collects light from the subject, and an imaging device that performs photoelectric conversion on the light collected by the optical unit 1 to output. The imaging device can be constituted of a charge coupled device (CCD), or a complementary metal oxide semiconductor (CMOS). The endoscope 90 may be a rigid endoscope without providing the flexible tube portion 91c in the insertion portion 91.

The operating unit 92 includes an angle operating unit 92a that operates a bent state of the bendable portion 91b, and a zoom operating unit 92b that instructs actuation of the voice coil motor 10 described above and performs zoom actions in the optical unit 1. The angle operating unit 92a can be formed in a knob shape, and the zoom operating unit 92b can be formed in a lever shape, but may take other forms, such as a volume switch and a push switch, respectively.

The universal cord 93 can be a member that connects the operating unit 92 and the control device 94. The endoscope 90 can be connected to the control device 94 through a connector 93a arranged in the proximal end portion of the universal cord 93.

In the insertion portion 91, the operating unit 92, and the universal cord 93, a cable 95, such as a wire, an electric wire, and an optical fiber, can be inserted.

The control device 94 includes a drive control unit 94a that controls the bent state of the bendable portion 91b, an image control unit 94b that controls the imaging unit 80, and a light-source control unit 94c that controls a light source device not illustrated. The control device 94 includes a processor, such as a central processing unit (CPU), and comprehensively controls the entire endoscope system 100.

The drive control unit 94a has an actuator, and can be mechanically connected with the operating unit 92 and the bendable portion 91b through a wire. The drive control unit 94a controls the bent state of the bendable portion 91b by moving the wire back and forth.

The image control unit 94b can be electrically connected to the imaging unit 80 and the operating unit 92 through an electric wire. The image control unit 94b performs drive control of the voice coil motor 10 included in the imaging unit 80, and processing of an image captured by the imaging unit 80. The image processed by the image control unit 94b can be displayed on a display device 96.

The light-source control unit 94c can be optically connected to the light source and the operating unit 92 through an optical fiber. The light-source control unit 94c controls brightness of the light source irradiated from the distal end portion 91a or the like.

The operating unit 92 may be formed separately from the insertion portion 91, and be configured to operate the insertion portion 91 by a remote control.

The endoscope system 100 with the configuration described above has the imaging unit 80 equipped with the optical unit 1 described above and, therefore, it can be compact, and can be capable of quick zoom adjustment, making it suitable for video recording.

Moreover, according to the endoscope system 100, because the magnet 12 can be provided in the movable portion 3 while the coil 11 can be provided in the fixing portion 2, it can be not necessary to move a cable connected to the coil 11. Therefore, there can be no risk of causing a break as a result of the cable moving in limited space in the distal end portion 91a of the endoscope 90, providing predetermined durability.

### Other Embodiments

Although the embodiments to implement the disclosure have so far been described, the disclosure can be not to be limited only to these embodiments. For example, the number of magnets to be provided in the movable portion 3 can be not limited to three sets as described in the first embodiment, but may be one set, or multiple sets, such as two sets or four sets, maybe provided.

Furthermore, an example has been explained in which three balls (the two first balls 8a and the second ball 8b) can be provided as the slider that slide along with the movable portion 3 when it moves, but at least two balls can be adopted as the slider as long as they can be arranged between the fixing-portion main body 20 and the movable portion 3 and smooth movement of the movable portion 3 can be thereby achieved. Moreover, other than balls, any part, such as a roller or a caterpillar, may be applied as long as it acts along with movement of the movable portion 3 to enable smooth movement of the movable portion 3.

Furthermore, the through hole 20a arranged in the fixing-portion main body 20 enable assembly of the magnet 12, and can be not necessarily required to pierce through to the outer periphery side in the radial direction.

Moreover, in the optical unit 1, arrangement of the coil 11 and the magnet 12 may be reversed. That is, it may be configured such that the coil 11 can be arranged in the movable portion 3, and the magnet 12 can be arranged in the fixing portion 2.

More effects and modifications can be easily derived by those skilled in the art. Therefore, broader aspects of the disclosure can be not limited to the specific details and the representative embodiment as expressed and described above. Accordingly, various modifications can be made without departing from the spirit or scope of the general inventive concept as defined by the appended claims and their equivalents.

According to the disclosure, an optical unit, and an endoscope in which deterioration of a sliding performance due to contact between metal components can be prevented can be realized.

Additional advantages and modifications will readily occur to those skilled in the art. Therefore, the disclosure in its broader aspects can be not limited to the specific details and representative embodiments shown and described herein. Accordingly, various modifications may be made without departing from the spirit or scope of the general inventive concept as defined by the appended claims and their equivalents.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Example 1. An optical unit comprising:
a fixing portion having a cylindrical shape;
a movable portion that is arranged movable inside the fixing portion, the movable portion being configured to hold a lens;
a first slider that is present between the fixing portion and the movable portion, the first slider being configured to slide along with movement of the movable portion;
a second slider that is present between the fixing portion and the movable portion at a position different from a position of the first slider, the second slider being configured to slide along with the movement of the movable portion;
a driver that includes a coil and a magnet, the driver being configured to move the movable portion in a direction of an optical axis of the lens relative to the fixing portion;
a biasing portion that is arranged outside the movable portion, the biasing portion being configured to cause the magnet to generate a biasing force to form a biased state in which the movable portion is drawn toward the fixing portion; and
a stopper that arranged between the movable portion and the fixing portion, that is made of a non-metal material, and that is separated from the fixing portion in the biased state, and is in contact with the fixing portion in a state in which the biased state is released.

Example 2. The optical unit according to Example 1, wherein
the stopper has a shape identical to either the first slider or the second slider.

Example 3. The optical unit according to Example 2, wherein
the stopper has a spherical shape.

Example 4. The optical unit according to Example 2, wherein
the stopper is made of a material same as a material of either the first slider or the second slider.

Example 5. The optical unit according to Example 4, wherein
the stopper is made of either resin or ceramic.

Example 6. The optical unit according to Example 1, wherein
the stopper is arranged on both sides of the movable portion in a direction in which the movable portion moves.

Example 7. The optical unit according to Example 1, further comprising:
a third slider that is aligned with the first slider in the direction of the optical axis of the optical unit and that is present between the fixing portion and the movable portion, the third slider being configured to slide along with the movement of the movable portion.

Example 8. The optical unit according to Example 7, wherein
the stopper is arranged on an opposite side of the first to the third sliders across the movable portion in a circumferential direction of the movable portion.

Example 9. The optical unit according to Example 7, wherein
the first to the third sliders are arranged at a position at which a center of gravity of the movable portion is located within a triangle formed by connecting centers of gravity of the respective sliders.

Example 10. The optical unit according to Example 1, wherein
the magnet includes three sets of a first and a second magnets that are arranged on different outer peripheral surfaces of the movable portion from one another, and
the first and the second magnets are respectively magnetized in a radial direction of the movable direction, and magnetic poles of the first and the second magnets face in opposite directions.

Example 11. The optical unit according to Example 1, wherein
the first slider is arranged at a position at which a rotational moment around the first slider is generated in the movable portion by a biasing force received by the magnet from the biasing portion.

Example 12. The optical unit according to Example 1, wherein
in the fixing portion, a first and a second rails that guide movement of the first and the second sliders, and a through hole that houses a part of the magnet are formed, the through hole being formed at a position facing the first and the second rails through a center axis of the fixing portion.

Example 13. The optical unit according to Example 1, wherein
the driver includes a plurality of coils aligned in the direction of the optical axis of the optical unit, and
the optical unit further includes a detecting device that is arranged between the coils, the detecting device being configured to output a detection signal to detect a position of the movable portion.

Example 14. An endoscope that is to be inserted into an inside of a subject to observe the inside of the subject, the endoscope comprising:
an optical unit;
an imaging device configured to convert light guided by the optical unit into an electrical signal; and
a controller configured to control driving of the optical unit, wherein
the optical unit includes:
a fixing portion having a cylindrical shape;
a movable portion that is arranged movable inside the fixing portion, the movable portion being configured to hold a lens;
a first slider that is present between the fixing portion and the movable portion, the first slider being configured to slide along with movement of the movable portion;
a second slider that is present between the fixing portion and the movable portion at a position different from a position of the first slider, the second slider being configured to slide along with the movement of the movable portion;
a driver that includes a coil and a magnet, the driver being configured to move the movable portion in a direction of an optical axis of the lens relative to the fixing portion;
a biasing portion that is arranged outside the movable portion, the biasing portion being configured to cause the magnet to generate a biasing force to form a biased state in which the movable portion is drawn toward the fixing portion; and
a stopper that arranged between the movable portion and the fixing portion, that is made of a non-metal material, and that is separated from the fixing portion in the biased state, and is in contact with the fixing portion in a state in which the biased state is released.

Example 15. The endoscope according to Example 14, wherein
the stopper has a shape identical to either the first slider or the second slider.

Example 16. The endoscope according to Example 15, wherein
the stopper has a spherical shape.

Example 17. The endoscope according to Example 15, wherein t
he stopper is made of a material same as a material of either the first slider or the second slider.

Example 18. The endoscope according to Example 17, wherein
the stopper is made of either resin or ceramic.

Example 19. The endoscope according to Example 14, wherein
the stopper is arranged on both sides of the movable portion in a direction in which the movable portion moves.

Example 20. The endoscope according to Example 14, further comprising
a third slider that is aligned with the first slider in the direction of the optical axis of the optical unit and that is present between the fixing portion and the movable portion, the third slider being configured to slide along with the movement of the movable portion, wherein
the stopper is arranged on an opposite side of the first to the third sliders across the movable portion in a circumferential direction of the movable portion.

What is claimed is:

1. An optical unit, comprising:
a lens unit including a fixed lens and a movable lens;
a frame, wherein the fixed lens is located in a distal section of the frame;
a movable portion located inside the frame, wherein the movable lens is located in the movable portion and wherein the movable portion is movable relative to the frame along an optical axis of the optical unit between a biased state and an unbiased state;
a first slider slidably arranged in a space between the frame and the movable portion; and
a stopper arranged in the space, the stopper made of a non-metal material,
wherein, in the biased state:
the stopper is spaced apart from the frame, and
wherein, in the unbiased state:
the stopper contacts the frame.

2. The optical unit according to claim 1, wherein the stopper has a shape identical to the first slider.

3. The optical unit according to claim 2, wherein the stopper is a ball bearing.

4. The optical unit according to claim 2, wherein the stopper and the first slider are made of a first material.

5. The optical unit according to claim 4, wherein the first material is a resin or a ceramic.

6. The optical unit according to claim 1, wherein the movable portion is in a first position in the biased state, and in a second position in the unbiased state, and
wherein the first position is closer to the distal section of the frame than the second position.

7. The optical unit according to claim 1, wherein the movable portion contacts the frame in the biased state, and the movable portion is spaced apart from the frame in the unbiased state.

8. The optical unit according to claim 1, wherein, in a direction of movement of the movable portion, the stopper is arranged on both sides of the movable portion.

9. The optical unit according to claim 1, further comprising:
a second slider slidably arranged in the space between the frame and the movable portion,
wherein the second slider is configured to slidably move along with a movement of the movable portion.

10. The optical unit according to claim 9, wherein the stopper is arranged on an opposite side of the movable portion from the first slider and the second slider.

11. The optical unit according to claim 9, wherein the first slider includes a first sub-slider and a second sub-slider, the first sub-slider spaced apart from the second sub-slider in a direction of the optical axis, and
wherein the first sub-slider, the second sub-slider, and the second slider are arranged such that a center of gravity of the movable portion is located within a triangle formed by connecting centers of gravity of the first sub-slider, the second sub-slider, and the second slider.

12. The optical unit according to claim 9, further comprising an actuator includes a coil and a first magnet unit, the actuator configured to move the movable portion relative to the frame in a direction of the optical axis,
wherein the first magnet unit includes three sets of magnets, each set of magnets including a first magnet and a second magnet arranged on different outer peripheral surfaces of the movable portion, and
wherein, in each set of magnets, the first magnet and the second magnet are respectively magnetized in a radial direction of the movable direction, and magnetic poles of the first magnet and the second magnet face in opposite directions.

13. The optical unit according to claim 12, further comprising a second magnet unit arranged radially outside the movable portion, the second magnet unit configured to cause the first magnet unit to generate a magnetic force that places the movable portion in the biased state,
wherein the first slider is located where a rotational moment around the first slider is generated in the movable portion by the magnetic force.

14. The optical unit according to claim 12, wherein the frame includes a first and a second rails that guide movement of the first and the second sliders, and a through passage that be formed at a position facing the first and the second rails through a center axis of the frame, and
wherein the through passage houses a part of the magnet unit.

15. The optical unit according to claim 1, further comprising:
coils; and
a sensor,
wherein the coils aligned along the optical axis, and
wherein the sensor is configured to output a detection signal to detect a position of the movable portion.

16. An endoscope for insertion into an inside of a subject to observe an inside of the subject, the endoscope comprising:
the optical unit according to claim 1;
an imaging device configured to convert light guided by the optical unit into an electrical signal; and
a controller configured to control driving of the optical unit.

17. The optical unit according to claim 1, wherein the first slider is located at a first position in a direction of the optical axis, the stopper is located at a second position in the direction of the optical axis.

18. The optical unit according to claim 1, wherein the first slider is distally located relative to the stopper in a direction of the optical axis.

19. The optical unit according to claim 1, wherein the movable portion has a protrusion, and
wherein the protrusion has a first recess and a second recces configured to respectively house the first slider and the stopper.

20. The optical unit according to claim 1, wherein the first recess has a first length in a direction of the optical axis,
wherein the second recess has a second length in the direction of the optical axis, and
wherein the first length is larger than the second length.
